(19) United States
(12) Patent Application Publication
(10) Pub. No.: US 2014/0295142 A1
(43) Pub. Date: Oct. 2, 2014

(54) STRUCTURED MATERIAL

(71) Applicant: CANON KABUSHIKI KAISHA, Tokyo (JP)

(72) Inventors: Masahiko Takahashi, Hachioji-shi (JP); Wataru Kubo, Inagi-shi (JP); Hirokatsu Miyata, Hadano-shi (JP)

(73) Assignee: CANON KABUSHIKI KAISHA, Tokyo (JP)

(21) Appl. No.: 14/225,284

(22) Filed: Mar. 25, 2014

(30) Foreign Application Priority Data
Mar. 29, 2013 (JP) 2013-073650

(51) Int. Cl. C01B 33/12

(52) U.S. Cl. CPC C01B 33/12
USPC 428/158; 428/163

(57) ABSTRACT

A structured material includes a base member, and a mesostructured member disposed on the surface of the base member. The mesostructured member includes a wall defining cylindrically shaped portions. The base member has a plurality of grooves periodically formed in the surface thereof. The grooves each have a bottom surface and side surfaces in a shape in which a plane including the bottom surface is perpendicular to planes including the side surfaces. The cylindrically shaped portions in a region opposite to the base member with respect to an imaginary surface of the base member defined by imaginarily filling grooves to form an even surface are oriented at angles within a range of ±10° with respect to a direction perpendicular to the longitudinal direction of the grooves.

### BACKGROUND OF THE INVENTION

1. Field of the Invention

The present invention relates to a structured material having a mesostructure that can be used for, for example, optical devices, light-emitting devices, carrier materials, chemical reaction field materials, and sensors.

2. Description of the Related Art

Japanese Patent Laid-Open No. 2001-145831 discloses a method for producing a mesostructured film having a two-dimensional hexagonal structure in which the orientation of cylindrical micelles is controlled by orientation regulation force of a rubbed polyimide layer.

Angew. Chem. Int. Ed., 46, 5364 (2007), Applied Physics Letters, 91, 023104 (2007), and Langmuir, 25, 11221 (2009) teach processes for forming a mesostructured material in which the orientation of cylindrical micelles is controlled in the spaces of microtrenches formed in the surface of a substrate.

These methods, however, have some disadvantages. In the method of Japanese Patent Laid-Open No. 2001-145831 in which the orientation is controlled by using a rubbed polyimide layer, the existence of such an organic interlayer between a mesostructured film and a substrate is liable to decrease the adhesion of the film to the substrate.

In the process using microtrenches described in Angew. Chem. Int. Ed., 46, 5364 (2007), the range of orientation control is limited to the regions within the microtrenches, and it is therefore difficult to form a continuous mesostructure whose orientation is controlled throughout the entire film. Even within the microtrenches, orientation regulation force is applied from three interfaces with two side surfaces and the bottom surface. Accordingly, the structural regularity of the resulting mesostructured material is not sufficient in an out-of-plane direction.

Applied Physics Letters, 91, 023104 (2007) describes a process for controlling the orientation of a mesostructured material using a substrate having a micro-grating structure at the surface thereof. However, this process limits the range of the orientation control to the region within the grating structure as with the case of Angew. Chem. Int. Ed., 46, 5364 (2007). Actually, it is described that when a mesostructured material has been formed to a level higher than the height of the grating structure, the orientation has not been controlled.

As with the case of Angew. Chem. Int. Ed., 46, 5364 (2007), Langmuir, 25, 11221 (2009) describes an orientation control process using microtrenches. In this case, the range of orientation control is limited to the regions within the microtrenches. Also, this document reports a phenomenon in which the mesostructured material is oriented in a direction perpendicular to the longitudinal direction of the microtrenches under specific conditions, and explains that this is because the surface of liquid in the trenches is deformed. Therefore, the process described in Langmuir, 25, 11221 (2009) is not suitable as a method for applying an orientation regulation force to a continuous mesostructured film completely covering the microtrenches.

### SUMMARY OF THE INVENTION

Accordingly, an embodiment of the present invention provides a structured material including a base member, and a mesostructured member on the surface of the base member, including a wall defining cylindrically shaped portions. The base member has a plurality of grooves periodically formed in the surface thereof. The grooves each have a bottom surface and side surfaces in a shape in which a plane including the bottom surface is perpendicular to planes including the side surfaces. The cylindrically shaped portions in a region opposite to the base member with respect to an imaginary surface of the base member defined by imaginarily filling grooves to form an even surface are oriented at angles within a range of ±10° with respect to a direction perpendicular to the longitudinal direction of the grooves.

Further features of the present invention will become apparent from the following description of exemplary embodiments with reference to the attached drawings.

### BRIEF DESCRIPTION OF THE DRAWINGS

FIG. 1 is a schematic perspective view of a structured material according to a first and a second embodiment.

FIGS. 2A and 2B are schematic sectional views of the structured materials of the first and the second embodiment.

FIGS. 3A to 3D are schematic perspective views of base members that can be used in the first and the second embodiment.

FIGS. 4A and 4B are schematic sectional views of the base members be used in the first and the second embodiment.

FIGS. 5A to 5C are schematic sectional views of the base members that can be used in the first and the second embodiment.

FIG. 6 is a representation of the relationship between the longitudinal direction of grooves in the base member and the orientation direction of cylindrically shaped portions, in the first and the second embodiment.

FIGS. 7A to 7D are representations of the relationships among the shape of grooves, the longitudinal direction of the grooves and the orientation direction of the cylindrically shaped portions, of base members according to the first and the second embodiment.

FIG. 8 is an SEM image of the surface of an oriented mesostructured film of Example 1.

FIG. 9 is an SEM image of a section of the oriented mesostructured film of Example 1.

FIG. 10 is an SEM image of a section of the oriented mesostructured film of Example 1.

FIG. 11 is a chart of φ scanned X-ray diffraction peak intensities of the oriented mesostructured film of Example 1.

FIG. 12 is an SEM image of a section of the oriented mesostructured film of Example 3.

FIG. 13 is an SEM image of a section of the oriented mesostructured film of Example 4.

FIG. 14 is an SEM image of a section of the oriented mesostructured film of Example 7.

### DESCRIPTION OF THE EMBODIMENTS

Embodiments of the invention will now be described with reference to the drawings.

### First Embodiment

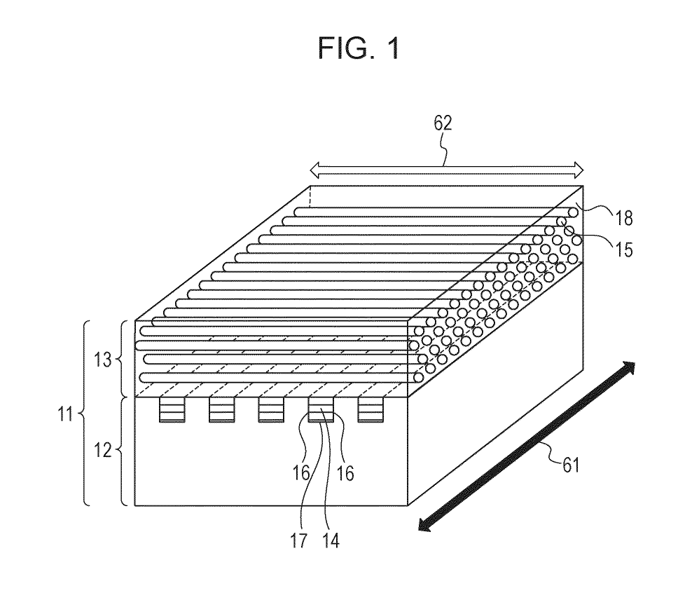

The structured material of an embodiment is shown in FIG. 1.

A structured material of an embodiment includes a base member, and a mesostructured member on the surface of the base member, including a wall defining cylindrically shaped portions. The base member has a plurality of grooves periodically formed in the surface thereof. The grooves each have a bottom surface and a side surface in a shape in which a plane including the bottom surface is perpendicular to a plane including the side surface. The cylindrically shaped portions in a region opposite to the base member with respect to an imaginary surface of the base member defined by imaginarily filling grooves to form an even surface are oriented at angles within a range of ±10° with respect to a direction perpendicular to the longitudinal direction of the grooves.

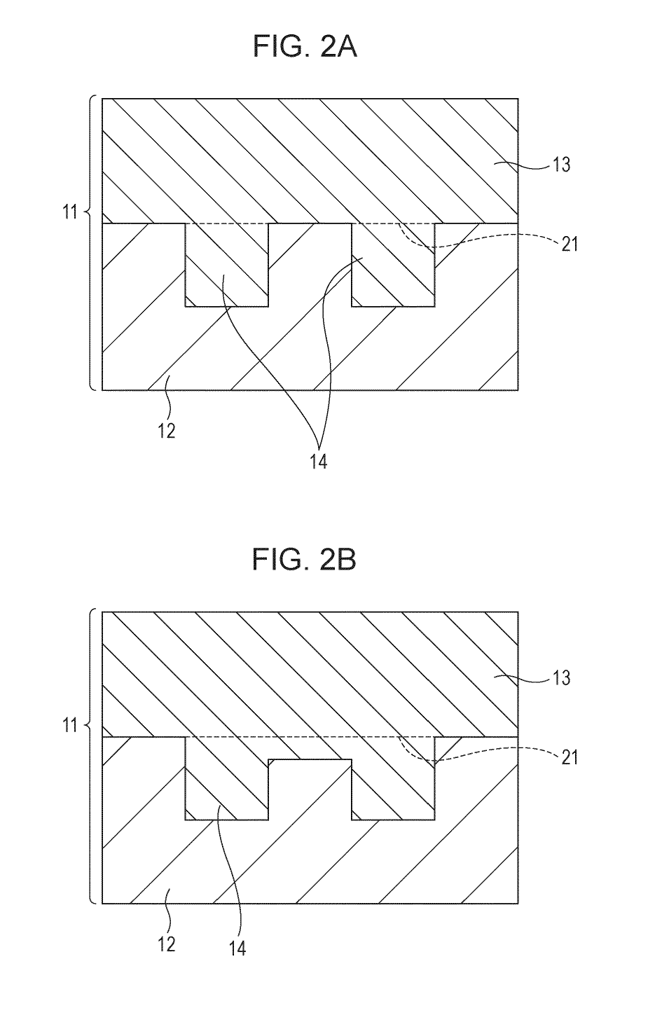

The structured material 11 of the present embodiment includes a base member 12, a mesostructured member 13 disposed on the surface of the base member 12, and mesostructured members 14 in the grooves. These components will be described in detail with reference to FIGS. 2A and 2B. FIG. 2A schematically shows the plurality of grooves periodically formed in the surface of the base member 12 at a substantially uniform depth. In the present embodiment and any other embodiment of the invention, the mesostructured member 13 opposite to the base member 12 with respect to the imaginary surface of the base member, which is the surface of the base member when it is presupposed that the grooves are filled to form a flat shape, may be referred to as the mesostructured member on the surface of the base member 12 in some cases. If some of the plurality of grooves periodically formed in the surface of the base member 12 have uneven depths, that is, if two side surfaces of any of the grooves have different heights, the imaginary surface 21 of the base member 12 is defined at such a level that the grooves are filled throughout the entire region thereof, as shown in FIG. 2B. In this instance, the mesostructured members 14 in the grooves may straddle two or more grooves. In the case where two side surfaces of any of the grooves have different heights, as described above, the two side surfaces of at least part of the plurality of grooves have different heights, that is, the two side surfaces of all the grooves may have different heights, or the two side surfaces of part of the grooves may have different heights.

A technique will be described with reference to FIG. 1 for controlling the orientation of the cylindrically shaped portions 15 of the mesostructured member 13 on the surface of the base member 12 in one direction. The base member 12 that contributes to such orientation control will first be described.

### Shape of Grooves

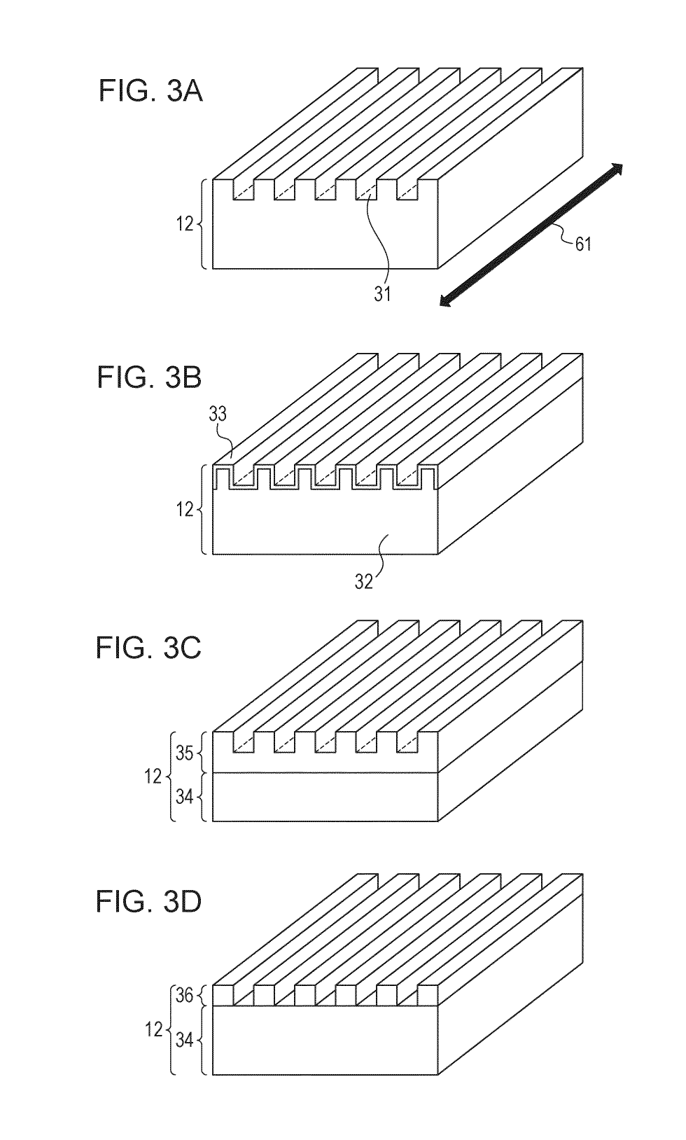

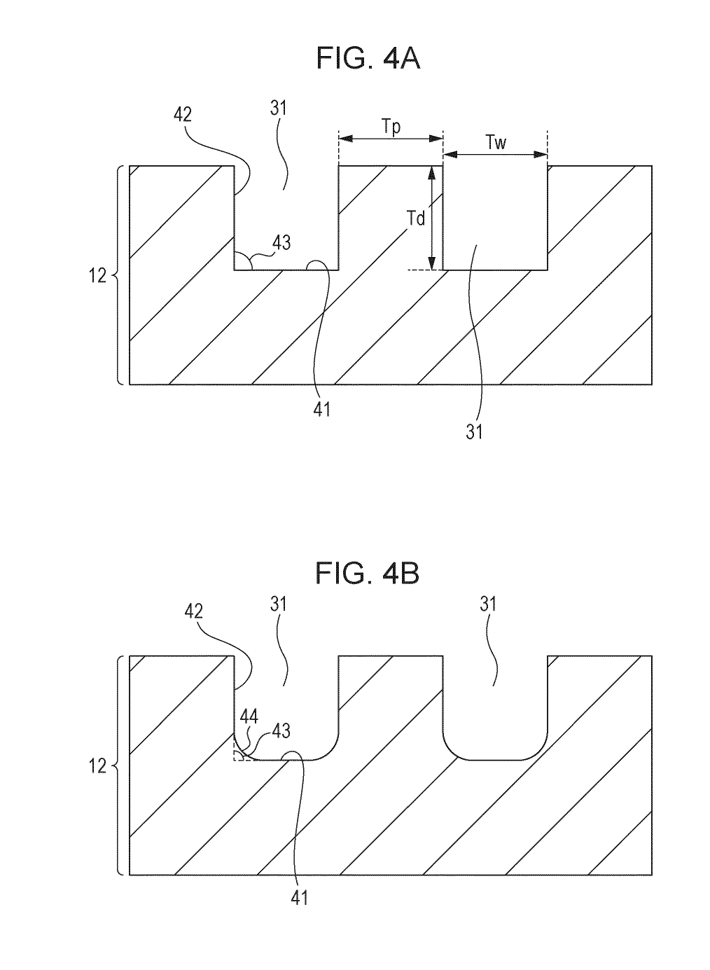

As shown in FIG. 3A, the base member 12 has a plurality of grooves 31 periodically arranged in the surface thereof. FIG. 4A shows a schematic sectional view of the base member 12 taken along a plane perpendicular to the longitudinal direction 61 of the grooves 31.

The plane including the bottom surface 41 of each groove is perpendicular to the planes including the side surfaces of the groove. More specifically, the angle 43 between the plane including the bottom surface 41 and the plane including a side surface 42 is rectangular (right angle). However, the rectangular angle 43 (right angle) mentioned herein is not necessarily strictly 90°, and may be in a range of angles at which orientation regulation force is produced as intended. More specifically, the angle 43 is preferably in the range of 85° to 100°.

The bottom surfaces 41 of the grooves 31 are desirably flat, but may have a small surface roughness of less than 5 nm in height at the surface thereof in the process for forming the grooves. Such a small surface roughness hardly affects the orientation control in the present embodiment and is negligible. The word “flat” mentioned herein implies that the bottom surfaces 41 are approximated by straight lines in the sectional view of FIG. 4A.

In the structure shown in FIG. 4A, the bottom surfaces 41 of the grooves are perpendicular to the side surfaces 42. However, orientation regulation force to the mesostructured member is produced even if the intersections of the bottom surface 41 and the side surfaces 42 (junctions of the bottom surface 41 and the side surfaces 42) of the groove 31 may be slightly rounded, or curved. FIG. 4B schematically shows such a case. In the present embodiment, the junction of the flat bottom surface 41 and the side surfaces 42 is not necessarily defined by a boundary in the strict sense, and may be defined in such a manner that a slightly rounded intersection 44 continuously connects the bottom and side surfaces. In this instance, the imaginary extension of the flat bottom surface 41 and the imaginary extension of the side surfaces 42, as indicated by the dotted lines in FIG. 4B, form an angle 43 in the range of 85° to 100°.

When the bottom surface 41 and the each side surface 42 intersect at the right angle, as shown in FIG. 4A, the structured material can be described as below. The structured material includes a base member having a plurality of grooves regularly formed in the surface thereof, and a mesostructured member disposed on the surface of the base member and having cylindrically shaped portions defined by a wall. The section of the base member taken along a plane perpendicular to the longitudinal direction of the grooves has rectangular recesses and rectangular protrusions at a portion adjacent to the mesostructured member. The mesostructured members in the grooves define regions A, and the portions of the base member adjacent to the grooves and acting as part of the surface of the base member define regions B. Regions A and regions B define region C, and region D lies opposite to the base member with respect to region C. The cylindrically shaped portions of the mesostructured member in region D are oriented at angles in a range of ±10° with respect to a direction perpendicular to the longitudinal direction of the grooves.

It is thought that the presence of grooves in the surface of the base member having such a shape in section allows orientation regulation force to act to orient cylindrical micelles at angles within a range of ±10° with respect to a direction perpendicular to the longitudinal direction of the grooves in the stage of forming the mesostructured member on the surface of the base member.

### Dimensions of Grooves

The dimensions of the grooves required for producing orientation regulation force will now be described with reference to FIG. 4A.

The grooves 31 of the base member 12 each have a depth Td and a width Tw. The depth Td and the width Tw desirably satisfy the following relationship:

2≧Tw/Td≧0.5

where 10 nm<Tw<1 μm and 10 nm<Td<1 μm

The reason is as below. When Tw/Td is less than 0.5, the width of the grooves is too small relative to the depth of the grooves. In this case, in the structure shown in FIG. 1, large orientation regulation force acts on the cylindrically shaped portions of the mesostructured members 14 in the grooves in the directions from the side surfaces 16 of each groove toward the center of the groove. Consequently, the orientation of the cylindrically shaped portions 15 in the mesostructured member 13 on the surface of the base member 12 may not be sufficiently controlled.

When Tw/Td is larger than 2, the width of the grooves is too large relative to the depth of the grooves. In this case, in the structure shown in FIG. 1, large orientation regulation force acts on the cylindrically shaped portions in the mesostructured members 14 in the grooves in the direction from the bottom surface 17 of each groove toward the center of the groove. Consequently, unoriented mesostructures are formed parallel to the bottom surfaces 17 of the grooves. Accordingly, the orientation of the cylindrically shaped portions 15 of the mesostructured member 13 on the surface of the base member 12 may not be sufficiently controlled.

The width Tw and the depth Td of the grooves are each desirably less than 1 μm. When either is 1 μm or more, in the structure shown in FIG. 1, the orientation regulation force from either the side surfaces 16 or the bottom surface 17 of the grooves acts considerably on the mesostructured members 14 in the grooves while the mesostructured members are formed. The orientation regulation force from these surfaces does not act to control the orientation in plane of the cylindrically shaped portions in one direction. Accordingly, the orientation direction of the cylindrically shaped portions 15 may not sufficiently be controlled in the mesostructured member 13 on the surface of the base member 12.

The distance Tp between adjacent grooves (intervals of the grooves) is desirably 2 μm or less. If the distance Tp is larger than 2 μm, the orientation of the cylindrically shaped portions 15 of the mesostructured member 13 on the surface of the base member, shown in FIG. 1, may not be sufficiently controlled.

Portions between Grooves

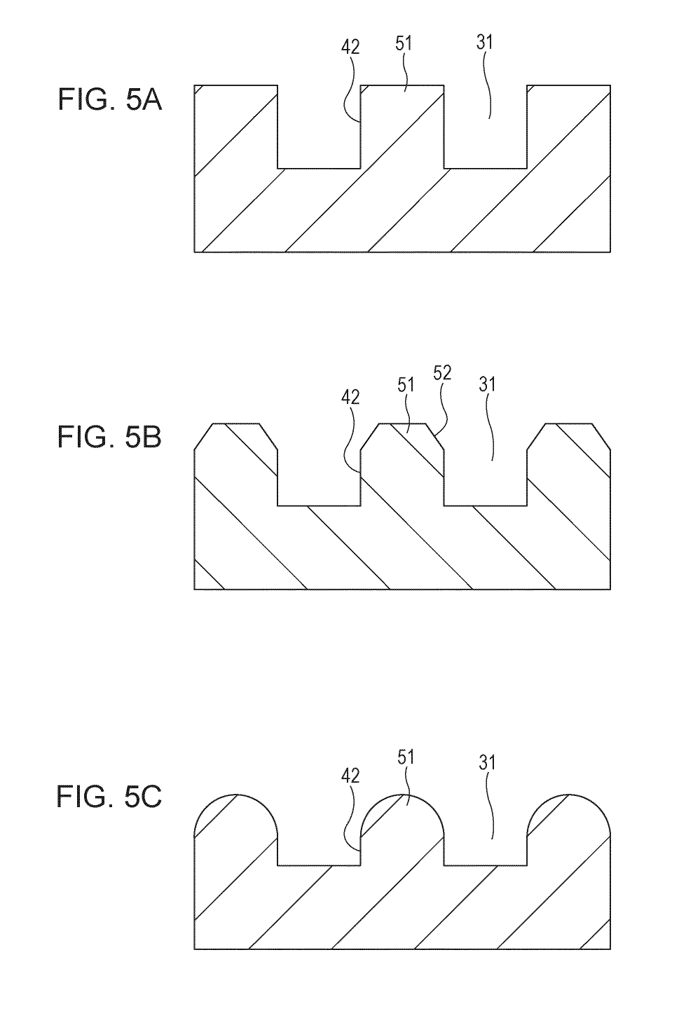

The shape of the portions between the grooves is not particularly limited as long as the shape of the grooves in section has the above-described features. FIGS. 5A to 5C are schematic sectional views of possible base members in the present embodiment. FIG. 5A shows a base member whose portions 51 between the grooves have an even surface. FIG. 5B shows a base member whose portions 51 between the grooves continue to the side surfaces 42 of the grooves through slants 52. FIG. 5C shows a base member whose portions 51 between the grooves have rounded surfaces, thereby continuously joined with the side surfaces 42 of the grooves. In these shapes, the depth Td of the grooves shown in FIG. 4A refers to the difference in height between the highest surface of the portion 51 between the grooves and the even bottom surface.

### Structure of Base Member

The base member having the grooves periodically formed in the surface thereof will now be described with reference to FIGS. 3A to 3D.

The base member 12 may be composed of a single layer as shown in FIG. 3A, or a plurality of layers. In the case of being composed of a plurality of layers, the base member 12 may include a first layer 32 having a plurality of grooves, and a second layer 33 disposed over the surface of the first layer along the shape of the grooves formed in the first layer, as shown in FIG. 3B, or may include a first layer 34 not having the grooves, and a second layer 35 having a plurality of grooves therein disposed over the surface of the first layer 34, as shown in FIG. 3C. Alternatively, as shown in FIG. 3D, the base member 12 may include a first layer 34 not having the grooves, and a plurality of columnar members 36 disposed on the surface of the first layer 34 in such a manner that one of the longitudinal surfaces of each columnar member 36 is in contact with the surface of the first layer 34 so as to define grooves.

In the case of the structure shown in FIG. 3A, the material of the base member 12 is selected desirably from the viewpoint of establishing good in-plane orientation of the mesostructured member, and, for example, silica or silicon may be selected. In the case of the structure shown in FIG. 3B, a silicon first layer 32 having recesses and protrusions may be provided with a silica second layer 33 thereon. In the case of the structure shown in FIG. 3C, the first layer 34 of the base member 12 can be made of any material, such as silicon or any other inorganic material, a metal, glass, or polyethylene terephthalate, and the second layer 35 may be made of silica or silicon. In the case of the structure shown in FIG. 3D, a silica or silicon first layer 34 may be provided with silica columnar members 36 thereon.

The base member 12 may have any shape, as long as grooves are periodically formed in the surface thereof and a mesostructured member can be formed on the surface thereof. For example, the shape of the base member 12 may be plate-like, curved, or lens-like.

The periodically arranged grooves can be formed by known processes including, for example, a patterning process using photolithography or electron beam drawing and an etching process.

### Mesostructured Member on the Surface of Base Member

The orientation-controlled mesostructured member of the present embodiment will now be described with reference to FIG. 1. The mesostructured member 13 on the surface of the base member 12 includes a wall 18 defining cylindrically shaped portions 15. The wall 18 does not necessarily completely fill the region around the cylindrically shaped portions 15, and may have nanoholes of 2 nm or less in diameter therein through which the cylindrically shaped portions 15 communicate with each other.

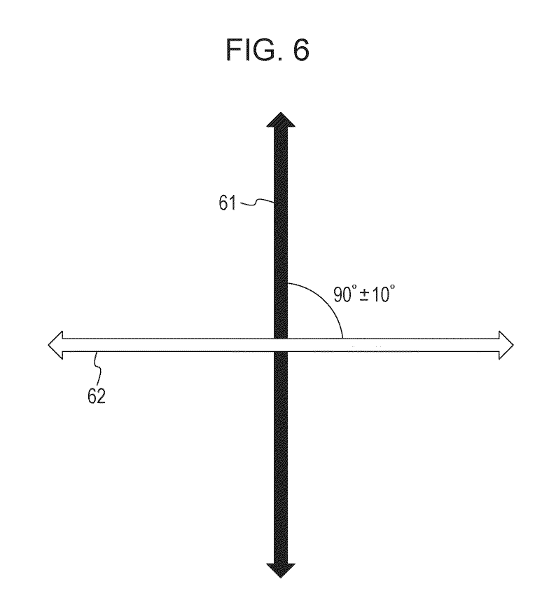

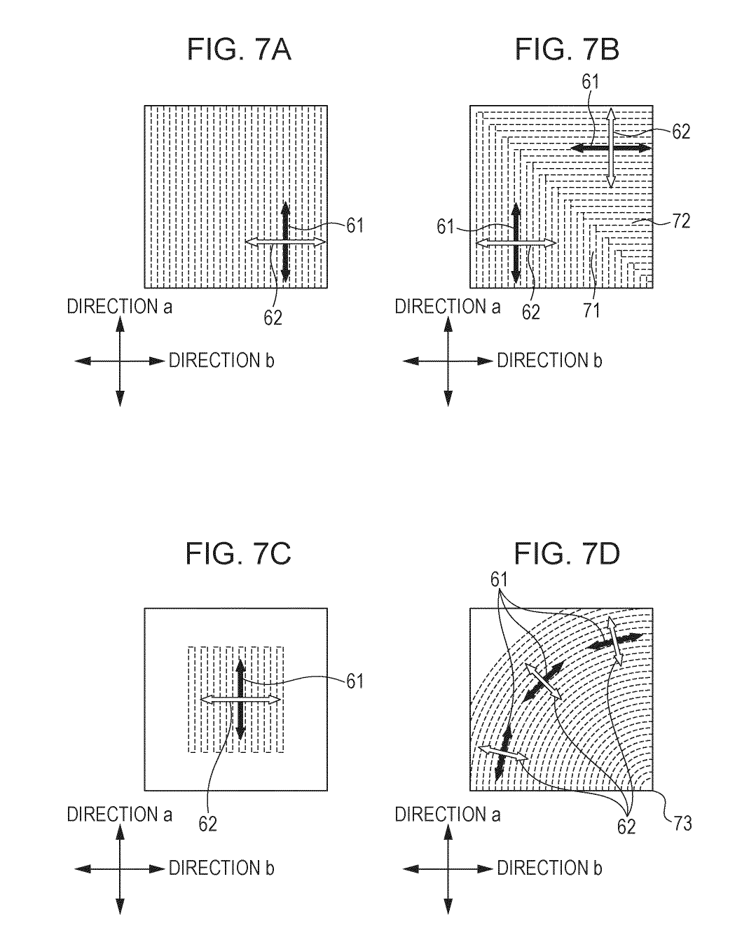

The cylindrically shaped portions 15 are oriented at angles within a range of ±10° with respect to a direction perpendicular to the longitudinal direction 61 of the grooves. FIGS. 6 and 7A to 7D show the relationships between the orientation direction 62 of the cylindrically shaped portions in the mesostructured member 13 on the surface of the base member 12 and the longitudinal direction 61 of the grooves in the surface of the base member 12. FIGS. 6 and 7A to 7D are schematic diagrams, when viewed from above, of the structured material 11 shown in FIG. 1, and as with FIG. 1, reference numeral 61 designates the longitudinal direction of the grooves in the surface of the base member 12, and reference numeral 62 designates the orientation direction of the cylindrically shaped portions of the mesostructured member on the surface of the base member 12.

As long as the cylindrically shaped portions 15 are oriented at angles within a range of ±10° with respect to a direction perpendicular to the longitudinal direction 61 of the grooves, the plurality of grooves may be in any form. For example, a plurality of straight grooves may be arranged in the same direction throughout the entire main surface of the base member 12, as shown in FIG. 7A. In FIGS. 7A to 7D, dotted lines schematically indicate the shape of each groove.

Alternatively, as shown in FIG. 7B, the base member may have a region 71 where a plurality of straight grooves are arranged parallel to direction a; and a region 72 where a plurality of straight grooves are arranged parallel to direction b different from direction a. When the grooves are arranged as shown in FIG. 7B, the cylindrically shaped portions of the mesostructured member in contact with the region 71 on the surface of the base member are oriented at angles within a range of ±10° with respect to a direction perpendicular to direction a, and the cylindrically shaped portion of the mesostructured member in contact with the region 72 on the surface of the base member are oriented at angles within a range of ±10° with respect to a direction perpendicular to direction b. The grooves may be periodically arranged in a part of the main surface of the base member, as shown in FIG. 7C. In this instance, the cylindrically shaped portions of the mesostructured member on the surface of the base member are oriented only on a part of the main surface of the base member, corresponding to the region where the grooves are present, at angles within a range of ±10° with respect to a direction perpendicular to the longitudinal direction 61 of the grooves. A plurality of curved grooves may be arranged in the surface of the base member, as shown in FIG. 7D. In this instance, the cylindrically shaped portions are radially oriented from the center 73 of the curves of the grooves.

The orientation-controlled portion of the mesostructured member may be limited to a region with a finite thickness near the surface of the base member, or may cover the entirety of the mesostructured member from the position near the surface of the base member to the boundary between the mesostructured member and the atmosphere.

### Material of Mesostructured Member

In the structured material shown in FIG. 1, the cylindrically shaped portions 15 of the mesostructured member 13 on the surface of the base member 12 may contain an organic material. For example, the organic material may be a material of amphiphilic molecules, such as a polyethylene oxide-polypropylene oxide (PEO-PPO) diblock copolymer or a polyethylene oxide-polypropylene oxide-polyethylene oxide (PEO-PPO-PEO) triblock copolymer.

When a diblock copolymer having a PEO-PPO structure is used, the number of repetitions of polyethylene oxide and the number of repetitions of polypropylene oxide are each preferably in the range of 10 to 500. Examples of such a PEO-PPO diblock copolymer include PEO68-PPO60 and PEO98-PPO60. When a triblock copolymer having a PEO-PPO-PEO structure is used, the number of repetitions of polyethylene oxide and the number of repetitions of polypropylene oxide are each preferably in the range of 10 to 200. Examples of such a PEO-PPO-PEO triblock copolymer include PEO20-PPO70-PEO20 and PEO106-PPO70-PEO106.

In the structured material shown in FIG. 1, the wall 18 of the mesostructured member 13 on the surface of the base member 12 is desirably made of an inorganic oxide, and particularly desirably made of silica, titania, or a mixture of these oxides.

The cylindrically shaped portions 15 are desirably arranged so as to form a two-dimensional hexagonal structure in the mesostructured member 13 on the surface of the base material 12. The two-dimensional hexagonal structure mentioned herein is such that when a section of the mesostructured member 13 is taken along a plane perpendicular to the orientation direction 62 of the cylindrically shaped portions, the circular sections of the cylindrically shaped portions 15 are arranged in a hexagonal close-packed manner in the matrix or the wall 18. Such a two-dimensional hexagonal structure leads to a highly regular arrangement of the cylindrically shaped portions in the mesostructured member 13 on the surface of the base 12. The cylindrically shaped portions 15 are arranged preferably with a structural period of 5 nm or more in an out-of-plane direction, more preferably 9 nm or more, and most preferably 15 nm or more. The out-of-plane direction mentioned herein refers to a direction perpendicular to the main surface of the base member.

A process will now be described for forming the mesostructured member 13 having orientation-controlled cylindrically shaped portions on the surface of the base member 12 having a plurality of grooves periodically formed therein.

The mesostructured member 13 on the surface of the base member 12 may be formed through the following steps:
(i) the step of applying a solution containing amphiphilic molecules, an inorganic oxide precursor, and a catalyst onto the surface of a base member having a plurality of grooves periodically formed therein; and
(ii) the step of producing an inorganic oxide from the precursor.

### Step (i)

A material having a plurality of grooves periodically formed in the surface thereof is used as the base member. In the present embodiment, the width of each groove is preferably 10 nm or more. A solution containing amphiphilic molecules, an inorganic oxide precursor and a catalyst is applied onto the surface of such a base member.

Any amphiphilic compound may be used as the amphiphilic molecules without particular limitation, as long as its aggregate can be used as a template for forming the mesostructured member. The amphiphilic compound is appropriately selected from the compounds that can form cylindrical micelles having dimensions according to the structural period of the desired mesostructured member.

Desirably, an amphiphilic compound is selected whose molecule includes a hydrophilic group and a hydrophobic group with a relatively small hydrophilic/hydrophobic contrast. A preferred amphiphilic compound may be a PEO-PPO diblock copolymer or a PEO-PPO-PEO triblock copolymer as mentioned above.

The solution containing amphiphilic molecules, an inorganic oxide precursor and a catalyst may further contain an additive for adjusting the structural period. The additive for adjusting the structural period may be a hydrophobic material. Examples of the hydrophobic material include alkanes, and aromatic compounds not containing a hydrophilic group. More specifically, octane, trimethylbenzene or the like may be used as the hydrophobic material.

Examples of the inorganic oxide precursor include alkoxides and halides of silicon or a metal. Examples of the alkoxide include methoxide, ethoxide, propoxide, and compounds in which part of alkoxide is substituted with an alkyl group. More specifically, tetramethoxysilane, tetraethoxysilane, tetrapropoxysilane, or the like may be used. As the halide, for example, a chloride may be used. Alternatively, a precursor that can introduce an organic group to an inorganic oxide skeleton may be used to form an organic-inorganic hybrid wall.

The application of the solution containing amphiphilic molecules, an inorganic oxide precursor, and a catalyst may be performed by coating, such as spin coating, dip coating, a cast method, or spray coating.

Among these coating techniques, suitable are dip coating performed at a withdrawal speed of less than 100 μm/s or a cast method. By forming the mesostructured member in a process taking a long time, orientation regulation force from the base member having the grooves periodically formed in the surface thereof acts to help the uniaxial orientation of the cylindrical micelles, thereby enabling a highly in-plane oriented structure to be reproducibly formed in the mesostructured member on the surface of the base member.

### Second Embodiment

In a structured material of a second embodiment, the cylindrically shaped portions of the mesostructured member may be hollow, or hollow with inner walls chemically modified with an organic material or the like. The second embodiment is the same as the first embodiment except for this feature.

The structured material of the present embodiment can be formed by a process including, for example, steps (i) and (ii) of forming the structured material of the first embodiment, and, in addition, step (iii) of removing the amphiphilic molecules by firing, extraction, or any other technique, and optional step (iv) of chemically modifying the inner walls of the cylindrically shaped hollow portions. The chemical modification may be performed by treating the surface of the wall with a silane coupling agent having an organic group according to the function to be given, such as alkyl, alkylfluoro, mercapto, or carboxy.

### EXAMPLES

### Example 1

A silica layer was formed by thermally oxidizing the surface of a silicon base, and a pattern of grooves was formed in the silica layer. The grooves had a depth Td and a width Tw of 500 nm each and were arranged at intervals (distances) Tp of 500 nm.

A solution containing tetraethoxysilane, a triblock copolymer having a PEO20-PPO70-PEO20 structure, ethanol, hydrochloric acid, and water was applied to the above-prepared base member by dip coating to form a mesostructured silica film acting as a mesostructured member. For dip coating, the base member was withdrawn at a speed of 20 μm/s.

The resulting mesostructured silica film was subjected to X-ray diffraction analysis. As a result, it was confirmed that cylindrical micelles to form cylindrically shaped portions were oriented in a direction perpendicular to the longitudinal direction of the grooves with a structural period d of 9 nm in an out-of-plane direction and in a manner of a two-dimensional hexagonal structure. This orientation-controlled two-dimensional hexagonal structure was kept in the thickness direction throughout the region from the highest surface of the base member between the grooves to a height of 500 nm or more. These results will be described below using the scanning electron micrographs (hereinafter refers to SEM images).

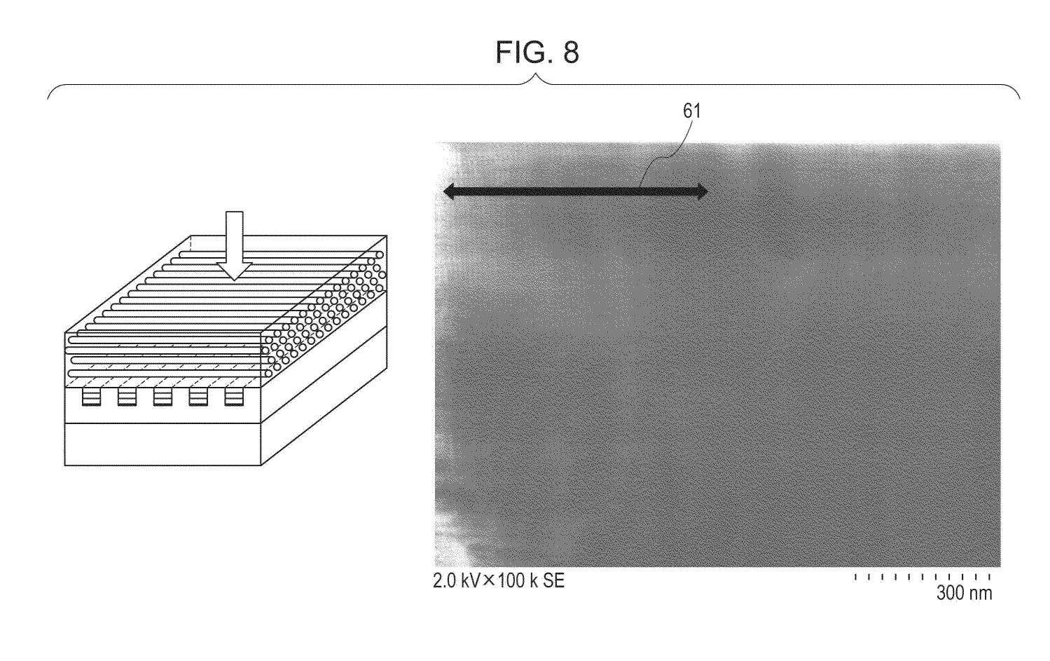

FIG. 8 shows an SEM image of the surface of the mesostructured silica film of the present example observed from the surface of the film and a schematic representation of the observation direction. As with FIG. 6, the arrow 61 shown in the surface SEM image indicates the longitudinal direction of the grooves in the surface of the base member. FIG. 8 shows that the orientation of the cylindrical micelles was controlled in a uniaxial manner in a direction substantially perpendicular to the longitudinal direction 61 of the grooves.

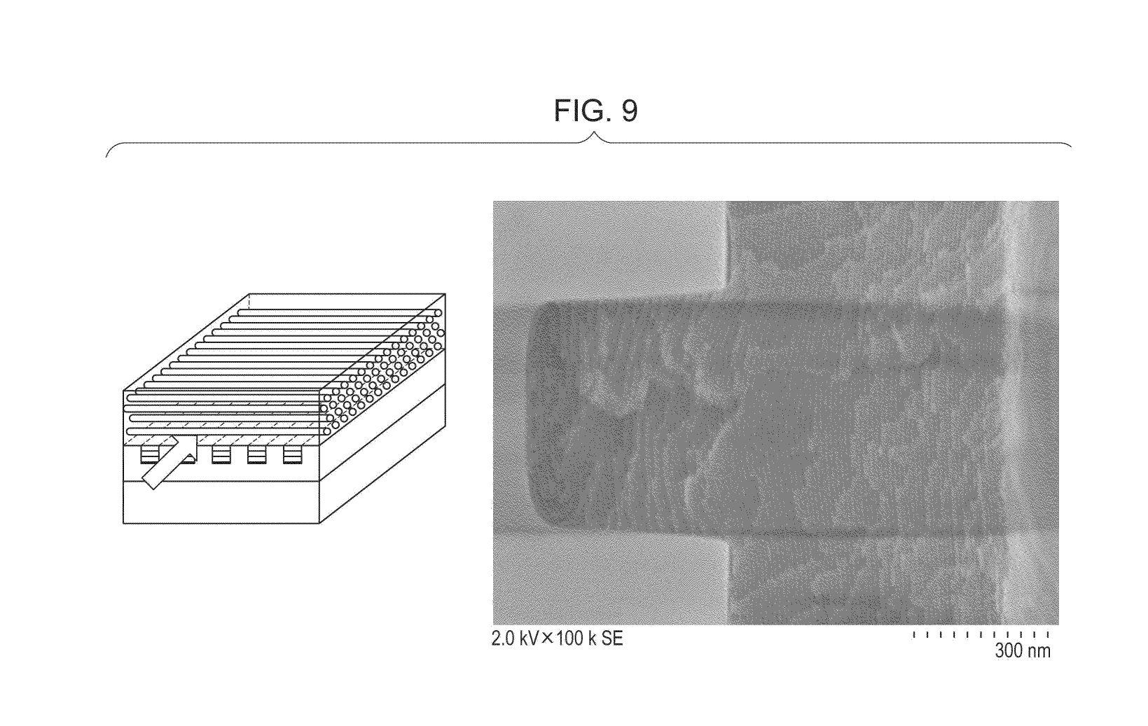

FIG. 9 shows an SEM image of a section of the film taken along a plane perpendicular to the longitudinal direction of the grooves and a schematic representation of the observation direction. The layered structure in FIG. 9 shows that the cylindrical micelles were oriented in plane, parallel to the highest surfaces between the grooves and the even bottom surfaces of the grooves, and in a direction perpendicular to the longitudinal direction of the grooves. Also, it was confirmed that the in-plane orientation of the cylindrical micelles was kept in the thickness direction throughout the region from the highest surface between the grooves to a height of 500 nm or more.

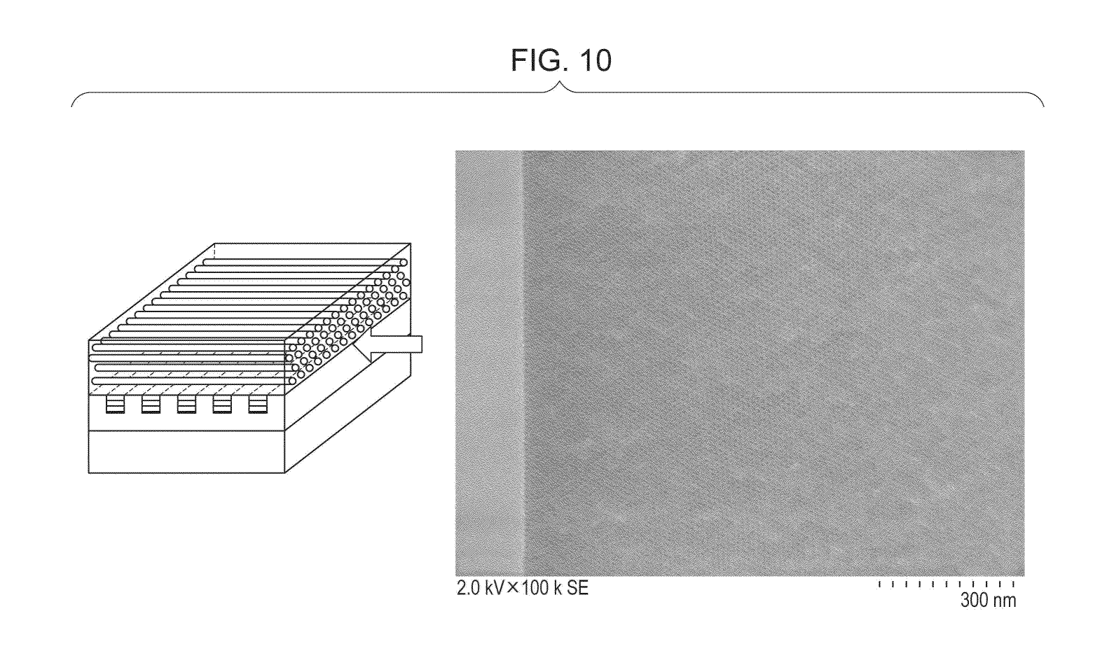

FIG. 10 shows an SEM image of a section of the film taken along a plane parallel to the longitudinal direction of the grooves and a schematic representation of the observation direction. It was confirmed from this figure that the cylindrical micelles were arranged in a manner of a two-dimensional hexagonal structure.

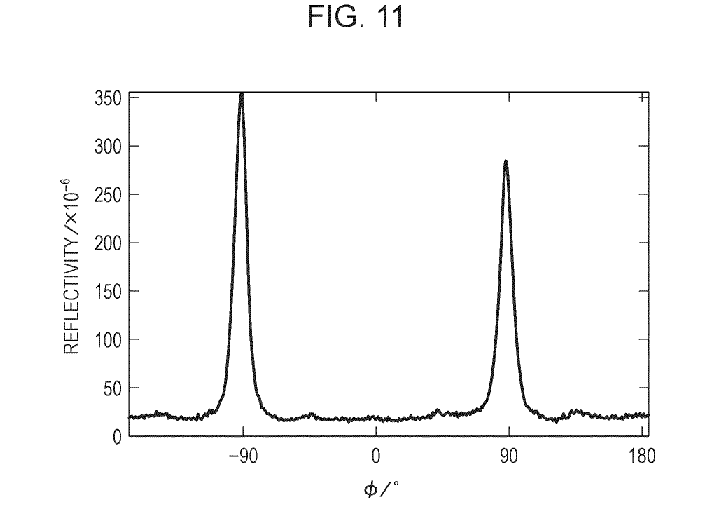

FIG. 11 shows a chart of X-ray peak intensities φ-scanned in the in-plane direction of the resulting mesostructured silica film as a result of evaluation for the in-plane orientation of the mesostructure. In this figure, the longitudinal direction of the grooves is 0°. The X-ray diffraction peaks of mesostructures appear at −90° and +90°, and the half-width of each peak is 10° or less. These results show that satisfactory uniaxial orientation was established.

### Example 2

A mesoporous silica film was formed from the mesostructured film produced in Example 1 by removing the triblock copolymer by solvent extraction at 80° C. using ethanol.

It was confirmed that the resulting mesoporous silica film had the same characteristics observed in Example 1 except that hollow cylindrically shaped portions were formed in the film by the removal of the triblock copolymer.

### Example 3

A mesostructured silica film was formed in the same manner as in Example 1, except that the grooves of the groove pattern had a depth Td and a width Tw of 250 nm each and were arranged at intervals (distances) Tp of 250 nm.

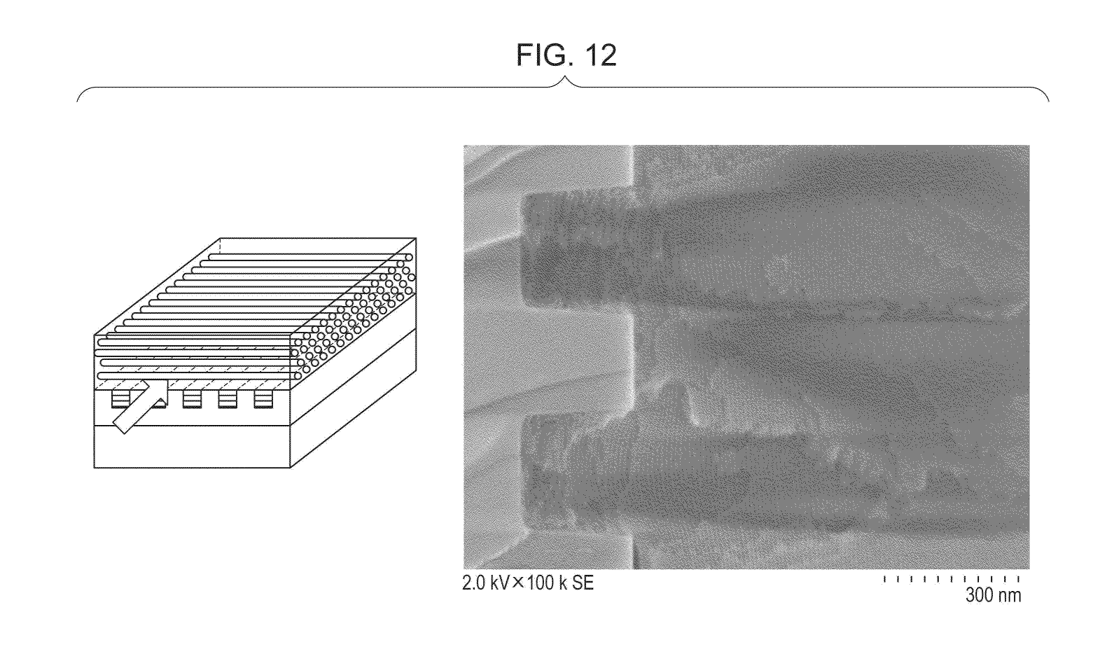

The resulting mesostructured silica film was subjected to X-ray diffraction analysis. As a result, it was confirmed that cylindrical micelles were oriented in a direction perpendicular to the longitudinal direction of the grooves with a structural period d of 9 nm in the out-of-plane direction and in a manner of a two-dimensional hexagonal structure as in Example 1. This orientation-controlled two-dimensional hexagonal structure was kept in the thickness direction throughout the region from the highest surface of the base member between the grooves to a height of 500 nm or more. As a representative of the results, an SEM image of a section of the film taken along a plane perpendicular to the longitudinal direction of the grooves is shown in FIG. 12 with a schematic representation of the observation direction.

### Example 4

A silica layer was formed by thermally oxidizing the surface of a silicon base, and a pattern of grooves was formed in the silica layer. The grooves had a depth Td and a width Tw of 250 nm each and were arranged at intervals (distances) Tp of 250 nm.

A solution containing tetraethoxysilane, a diblock copolymer having a PEO98-PPO60 structure, ethanol, hydrochloric acid, and water was applied to the above-prepared base member by dip coating to form a mesostructured silica film acting as a mesostructured member. For dip coating, the base member was withdrawn at a speed of 20 μm/s.

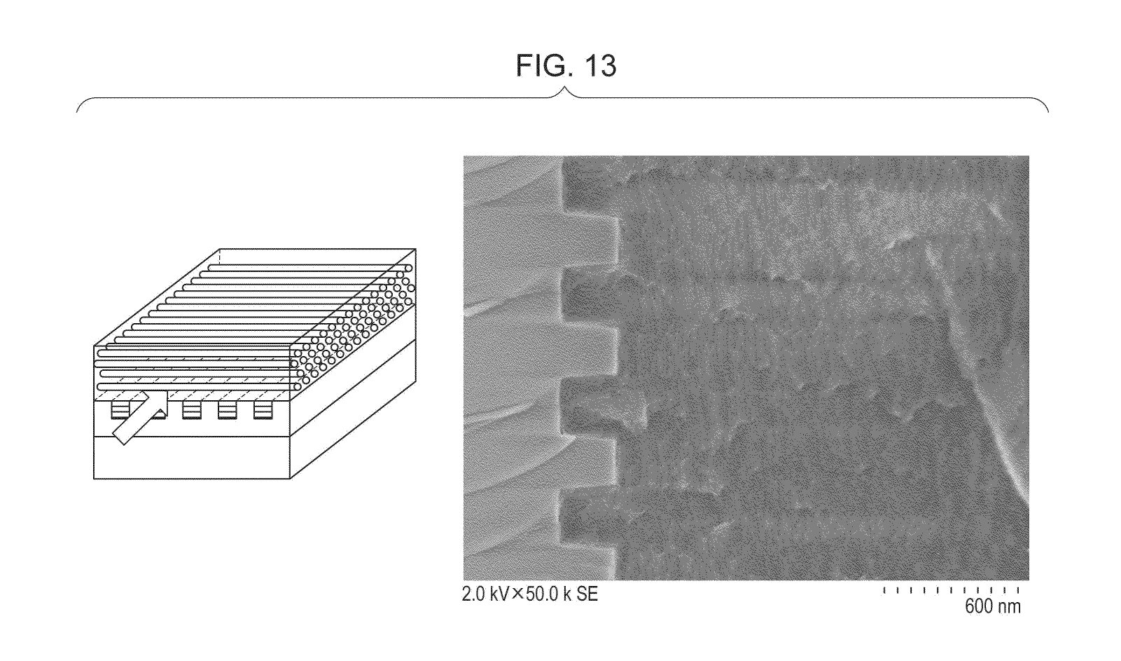

The resulting mesostructured silica film was subjected to X-ray diffraction analysis. As a result, it was confirmed that cylindrical micelles were oriented in a direction perpendicular to the longitudinal direction of the grooves with a structural period d of 16 nm in the out-of-plane direction and in a manner of a two-dimensional hexagonal structure. This orientation-controlled two-dimensional hexagonal structure was kept in the thickness direction throughout the region from the highest surface of the base member between the grooves to a height of 500 nm or more. As a representative of the results, an SEM image of a section of the film taken along a plane perpendicular to the longitudinal direction of the grooves is shown in FIG. 13 with a schematic representation of the observation direction.

### Example 5

A mesostructured silica film was formed in the same manner as in Example 4, except that the diblock copolymer had a PEO68-PPO60 structure.

The resulting mesostructured silica film was subjected to X-ray diffraction analysis. As a result, it was confirmed that cylindrical micelles were oriented in a direction substantially perpendicular to the longitudinal direction of the grooves with a structural period d of 14 nm in the out-of-plane direction and in a manner of a two-dimensional hexagonal structure. This orientation-controlled two-dimensional hexagonal structure was kept in the thickness direction throughout the region from the highest surface of the base member between the grooves to a height of 500 nm or more.

### Example 6

A silica layer was formed by thermally oxidizing the surface of a silicon base, and a pattern of grooves was formed in the silica layer. The grooves had a depth Td and a width Tw of 500 nm each and were arranged at intervals (distances) Tp of 500 nm.

A solution containing tetraisopropyl titanate, a triblock copolymer having a PEO20-PPO70-PEO20 structure, 1-butanol, hydrochloric acid, and water was applied to the above-prepared base member by dip coating to form an oriented mesostructured titania film. For dip coating, the base member was withdrawn at a speed of 20 μm/s.

The resulting mesostructured titania film was subjected to X-ray diffraction analysis. As a result, it was confirmed that cylindrical micelles were oriented in a direction substantially perpendicular to the longitudinal direction of the grooves with a structural period d of 9 nm in the out-of-plane direction and in a manner of a two-dimensional hexagonal structure. This orientation-controlled two-dimensional hexagonal structure was kept in the thickness direction throughout the region from the highest surface of the base member between the grooves to a height of 500 nm or more.

### Example 7

A mesostructured silica film was formed in the same manner as in Example 1, except that the base member having the pattern of grooves described in Example 1 in the surface thereof was treated for 333 seconds to deform the portions between the grooves by plasma etching using Ar gas. Consequently, the highest surfaces between the grooves continue to the side surfaces through slants.

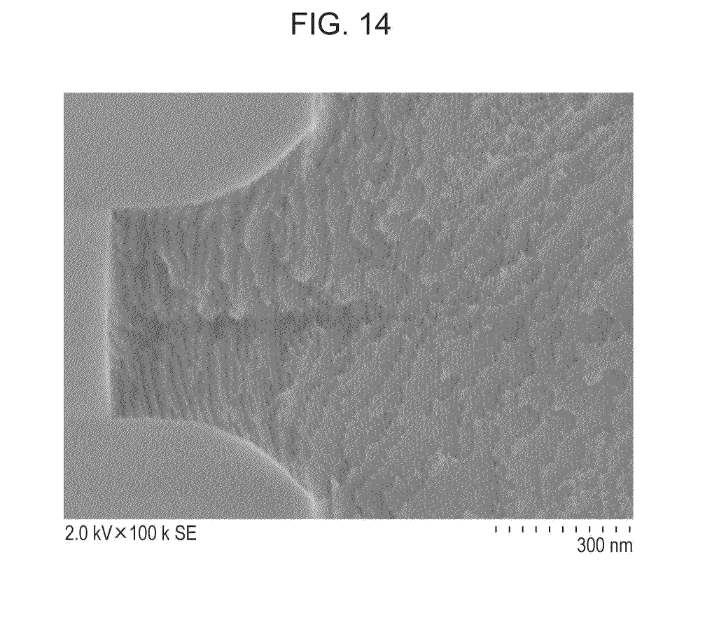

The resulting mesostructured silica film was subjected to X-ray diffraction analysis. As a result, it was confirmed that cylindrical micelles were oriented in a direction perpendicular to the longitudinal direction of the grooves with a structural period d of 9 nm in the out-of-plane direction and in a manner of a two-dimensional hexagonal structure as in Example 1. This orientation-controlled two-dimensional hexagonal structure was kept in the thickness direction throughout the region from the highest surface of the base member between the grooves to a height of 500 nm or more. As a representative of the results, FIG. 14 shows an SEM image of a section of the film taken along a plane perpendicular to the longitudinal direction of the grooves. Example 7 shows that the portions between the grooves are not necessarily defined by a single flat face, and that the orientation can be controlled as long as at least the bottom surface and side surfaces of the grooves have the features described above.

The embodiments of the present invention can achieve oriented mesostructured materials having high structural regularity and a large structural period without decreasing their adhesion to the substrate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-073650 filed Mar. 29, 2013, which is hereby incorporated by reference herein in its entirety.

What is claimed is:

1. A structured material comprising:
a base member having a surface in which a plurality of grooves are periodically formed, the grooves each having a bottom surface and side surfaces in a shape in which a plane including the bottom surface is perpendicular to planes including the side surfaces; and
a mesostructured member on the surface of the base member, the mesostructured member including a wall defining cylindrically shaped portions, the cylindrically shaped portions lying at least in a region opposite to the base member with respect to an imaginary surface of the base member defined by imaginarily filling grooves to form an even surface, the cylindrically shaped portions in that region being oriented at angles within a range of ±10° with respect to a direction perpendicular to the longitudinal direction of the grooves.

2. The structured material according to claim 1, wherein the plane including the bottom surfaces of the grooves forms an angle in the range of 85° to 100° with each of the planes including the side surfaces of the grooves.

3. The structured material according to claim 1, wherein the bottom surface and the side surface of the grooves are joined with each other in a curved manner.

4. The structured material according to claim 1, wherein the bottom surface and the side surface of the grooves are joined at a right angle.

5. The structured material according to claim 1, wherein at least part of the grooves each have two sides having different heights.

6. The structured material according to claim 1, satisfying the following relationship:
2≧Tw/Td≧0.5
wherein Tw represents the width of the grooves satisfying 10 nm<Tw<1 μm, and Td represents the depth of the grooves satisfying 10 nm<Td<1 μm.

7. The structured material according to claim 1, wherein the grooves are arranged at intervals of 2 μm or less.

8. The structured material according to claim 1, wherein the grooves are present in the entirety of the main surface of the base member.

9. The structured material according to claim 1, wherein the cylindrically shaped portions are arranged with a structural period of 9 nm or more in an out-of-plane direction.

10. The structured material according to claim 1, wherein the cylindrically shaped portions are arranged with a structural period of 15 nm or more in an out-of-plane direction.

11. The structured material according to claim 1, wherein the wall is made of a material selected from the group consisting of silica, titania, and a mixture of silica and titania.

12. The structured material according to claim 1, wherein the portion of the base member in which the grooves are formed is made of silica.

13. The structured material according to claim 1, wherein the cylindrically shaped portions are hollow.

14. The structured material according to claim 1, wherein the cylindrically shaped portions contains a polyethylene oxide-polypropylene oxide diblock copolymer.

15. The structured material according to claim 1, wherein the cylindrically shaped portions are arranged in a manner forming a two-dimensional hexagonal structure.
